(19) United States
(12) Patent Application Publication
(10) Pub. No.: US 2018/0026464 A1
(43) Pub. Date: Jan. 25, 2018

(54) METHOD OF CHARGING LITHIUM METAL BATTERY

(71) Applicants: SAMSUNG ELECTRONICS CO., LTD., Suwon-si (KR); Samsung SDI Co., Ltd., Yongin-si (KR)

(72) Inventors: Wonseok CHANG, Suwon-si (KR); Myunghoon KIM, Suwon-si (KR); Hyorang KANG, Suwon-si (KR); Toshinori SUGIMOTO, Suwon-si (KR); Taehwan YU, Suwon-si (KR); Yonggun LEE, Suwon-si (KR); Hongsoo CHOI, Suwon-si (KR)

(21) Appl. No.: 15/389,774

(22) Filed: Dec. 23, 2016

(30) Foreign Application Priority Data
Jul. 21, 2016 (KR) 10-2016-0092896

(51) Int. Cl. H02J 7/00

(52) U.S. Cl. CPC H02J 7/0052

(57) ABSTRACT

A method of charging a lithium metal battery includes charging the lithium metal battery so that a constant voltage period and a first constant current period are separated from each other in time where, the lithium metal battery is charged so that a second constant current period occurs between the first constant current period and the constant voltage period, and a current value of the second constant current period is less than a current value of the first constant current period.

### CROSS-REFERENCE TO RELATED APPLICATION

This application claims priority to Korean Patent Application No. 10-2016-0092896, filed on Jul. 21, 2016, and all the benefits accruing therefrom under 35 U.S.C. §119, the content of which in its entirety is herein incorporated by reference.

### BACKGROUND

### 1. Field

The present disclosure relates to a lithium metal battery, and more particularly, to methods of charging the lithium metal battery.

### 2. Description of the Related Art

When a lithium metal battery is charged by a conventional charging method, the greater a charge current is increased, the greater a dendritic growth of lithium is increased.

### SUMMARY

A lifetime and safety of a lithium metal battery may be reduced by a conventional charging method.

Provided are methods of charging a lithium metal battery while reducing a battery charge time and ensuring other advantages.

Provided are methods of charging a lithium metal battery, in which a constant current period and a constant voltage period are separated from each other with a time-lag.

Additional embodiments will be set forth in part in the description which follows and, in part, will be apparent from the description, or may be learned by practice of the presented embodiments.

According to an embodiment, a method of charging a lithium metal battery includes charging the lithium metal battery so that a constant voltage period and a first constant current period are separated from each other in time.

In an embodiment, the lithium metal battery may be charged so that a second constant current period occurs between the first constant current period and the constant voltage period, where a current value of the second constant current period may be less than that of the first constant current period.

In an embodiment, the lithium metal battery may be charged so that a third constant current period occurs between the second constant current period and the constant voltage period, and a current value of the third constant current period may be less than that of the second constant current period.

In an embodiment, when a voltage of the constant voltage period is referred to as V1, the second constant current period may occur at a voltage equal to or greater than approximately 0.80V1.

In an embodiment, when a voltage of the constant voltage period is referred to as V1, the third constant current period may occur at a voltage equal to or greater than approximately 0.90V1.

In an embodiment, a current value of the second constant current period may be equal to or less than approximately 80 percent (%) of the current value of the first constant current period.

In an embodiment, a current value of the third constant current period may be equal to or less than approximately 60% of the current value of the first constant current period.

According to another embodiment, a method includes reducing a charge current to be lower than a current of the constant current period before a constant voltage period occurs.

In an embodiment, the reducing the charge current may include discontinuously reducing the charge current until the point when the constant voltage period starts.

In an embodiment, the reducing the charge current may include reducing the charge current at least once.

In an embodiment, the reducing the charge current may include reducing the charge current at a voltage equal to or greater than approximately 80%, for example, approximately 95% of the voltage of the constant voltage period.

According to another embodiment, a method of charging a lithium metal battery, in which a constant voltage period and a constant current period occur, includes confirming the occurrence of a voltage drop before the constant voltage period occurs, measuring the degree of voltage drop when the constant voltage period occurs, comparing the degree of voltage drop with a set value, and reducing a charge current when the degree of the voltage drop is greater than the set value.

In an embodiment, when the degree of voltage drop is less than the set value, the reducing of the charge current may include maintaining the charge current without reducing the charge current.

In an embodiment, when another voltage drop occurs after the charge current is reduced, a subsequent process may be performed according to the processes that are performed after the voltage drop is occurred.

In an embodiment, the reducing the charge current may include reducing the charge current to be equal to or less than approximately 80%, for example, approximately 70% of a current value of the constant voltage period.

In an embodiment, the voltage drop may occur at a voltage equal to or greater than 80% of the voltage of the constant voltage period.

In an embodiment, another voltage drop may occur at a voltage equal to or greater than approximately 90%, for example, approximately 97% of the voltage of the constant voltage period.

In an embodiment, when the reducing the charge current is repeated after the reducing the charge current, the charge current is reduced to be equal to or less than approximately 60%, for example, approximately 50% of the current value of the constant current period.

### BRIEF DESCRIPTION OF THE DRAWINGS

These and/or other embodiments will become apparent and more readily appreciated from the following description of the embodiments, taken in conjunction with the accompanying drawings in which:

FIG. 1 is a cross-sectional view of a lithium metal battery to which an embodiment of a method of charging a lithium metal battery is applied;

FIG. 2 is a flowchart of an embodiment of a method of charging a lithium metal battery;

FIG. 3 is a graph showing a result of an experiment performed by an embodiment of a method of charging a lithium metal battery;

FIG. 4 is a graph showing a result of an experiment performed by a conventional charging method of the related art to compare the result of the experiment of FIG. 3;

FIG. 5 is a graph showing a capacity of a lithium metal battery charged according to the charging method of FIG. 3;

FIG. 6 is a graph showing a capacity of a lithium metal battery charged according to the charging method of FIG. 4; and

FIG. 7 is a graph showing capacity retentions of lithium metal batteries obtained from the experiment results of FIGS. 3 and 4.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this invention will be thorough and complete, and will fully convey the scope of the invention to those skilled in the art. Like reference numerals refer to like elements throughout.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. In an exemplary embodiment, when the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, when the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. In an exemplary embodiment, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

A method of charging a lithium metal battery will be described in detail with reference to accompanying drawings. In the drawings, thicknesses of layers or regions may be exaggerated for convenience of clarity.

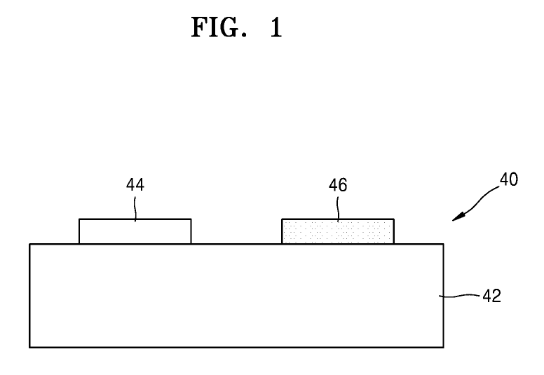

As depicted in FIG. 1, the method of charging a lithium metal battery according to an embodiment may be applied to a case that a cathode 46 of the battery 40 is a lithium metal. In an embodiment, the cathode 46 may be comprised of lithium, for example. In another embodiment, the cathode 46 may be a metal including lithium, for example. Reference numerals 42 and 44 respectively indicate a battery main body 42 and an anode 44.

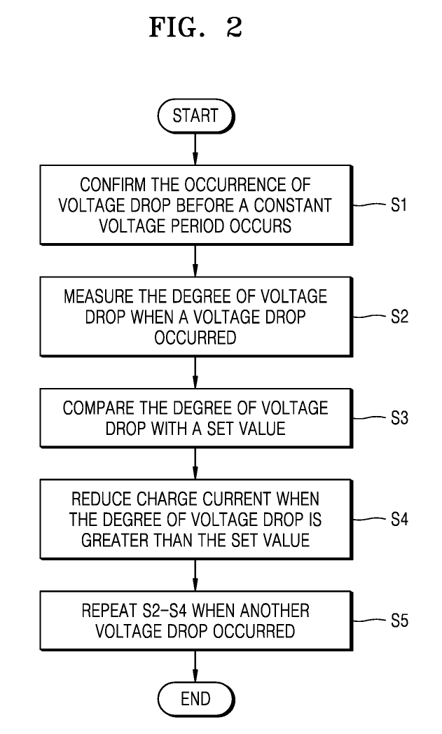

FIG. 2 is a flowchart of a method of charging a lithium metal battery, according to an embodiment.

Referring to FIG. 2, the method of charging a lithium metal battery includes confirming an occurrence of voltage drop before a constant voltage period occurs (S1).

In the lithium metal battery, the time that the constant voltage period after starting a charge occurs may be known in a process of charging a lithium metal battery by a conventional charging method.

In the confirmation of the occurrence of the voltage drop (S1), when the voltage drop occurs, the degree of voltage drop is measured (S2).

Next, the degree of voltage drop is compared with a standard value (hereinafter, a set value) (S3).

When the degree of voltage drop is greater than the set value, a charge current is reduced (S4).

The charge current may be constantly supplied before the charge current is reduced. That is, a constant current period may be maintained until the charge current is reduced. At this point, during the constant current period, the lithium metal battery may be charged with a constant current value of 1 C, e.g., approximately 230 milliampere (mA) per hour.

In operation S4, the charge current is reduced lower than a current value during the constant current period, and the degree of lowering may vary depending on the frequency of occurrence of the voltage drop. In an embodiment, after starting the charge of the lithium metal battery, a charge current is stopped from being applied for a moment to sense a charge degree of the lithium metal battery, for example. At this point, a voltage drop occurs. When the voltage drop occurs at a voltage corresponding to a predetermined value of a voltage of the constant voltage period, for example, at a voltage equal to or greater than 80 percent (%) of the voltage of the constant voltage period, in operation S4, the charge current may be reduced to be equal to or less than approximately 80% of a current value of the constant current period, and for example, may be reduced to be equal to or less than approximately 70% of a current value of the constant current period. When the voltage drop occurs at a second sense for sensing a charge degree and the degree of voltage drop is greater than the set value, in operation S4, the charge current may be reduced to be equal to or less than approximately 60% of a current value of the constant current period, and for example, may be reduced to be equal to or less than approximately 50% of a current value of the constant current period.

After operation S4, when another voltage drop occurs in connection with a sensing of the degree of charging, operation S2 through operation S4 may be repeated. After operation S4, the charge current is maintained constant until another voltage drop occurs. That is, when the constant current period occurring at a first time is referred to as a first constant current period, after the charge current in operation S4 is reduced, the charge current is maintained as a reduced current value until another voltage drop occurs, and this period may be referred to as a second constant current period. The other voltage drop may occur at a voltage equal to or greater than 90% of the voltage during the constant voltage period, for example, may occur at a voltage equal to or greater than approximately 97% of the voltage during the constant voltage period.

After the other voltage drop has occurred, the charge current may be reduced to be lower than the current value of the second constant current period through operation S2 and operation S4, and the charge current may be maintained constant until the constant current period occurs, and this period may be referred to as a third constant current period. There may be at least one constant current period between the third constant current period and the constant voltage period.

When the charge is controlled so as not to cause another voltage drop, the constant voltage period may occur when the second constant current period has finished. That is, a process of sensing the degree of charge of a lithium metal battery may be performed once before the constant voltage period occurs, and accordingly, the voltage drop may occur once.

In operation S3, when the degree of voltage drop is not large, compared with the set value, a first time constant current period, that is, the first constant current period, may be maintained.

In a charging method in which the constant voltage period occurs right after the first constant current period, that is, in a charging method of a conventional CC-CV in which the second constant current period does not exist, a point when the voltage drop occurs may be a point corresponding to a current equal to or greater than approximately 90%, for example, approximately 95% of a current value of the first constant current period. In detail, until approximately 95% of the first constant current period, the charge may be performed by 1 C, and after approximately 95% of the first constant current period, the charge may be performed with a value lower than 1 C, for example, 0.7 C until another voltage drop occurs. The other voltage drop may occur at a point corresponding to a current equal to or greater than approximately 96%, for example, approximately 98% of the current value of the first constant current period. Charge from the point when the other voltage drop occurs may be performed at a rate of, for example, 0.5 C.

As described above, the constant voltage period may be reduced, compared to the constant voltage period of the related art, by reducing a charge current in advance before a constant voltage period occurs in a process of charging a lithium metal battery. Accordingly, a charge time may be reduced. That is, a high speed charge is possible.

Throughout the whole charge process of FIG. 2, the time for measuring the voltage drop and the control of a charge current according to the voltage drop is very small, as compared to the whole charge time. Therefore, the time for measuring the voltage drop and the control of the charge current may not affect the total charge time.

Also, in the embodiment of the charging method of FIG. 2, the charge may be consecutively performed from the start to the end, and accordingly, a practical pause time is unnecessary.

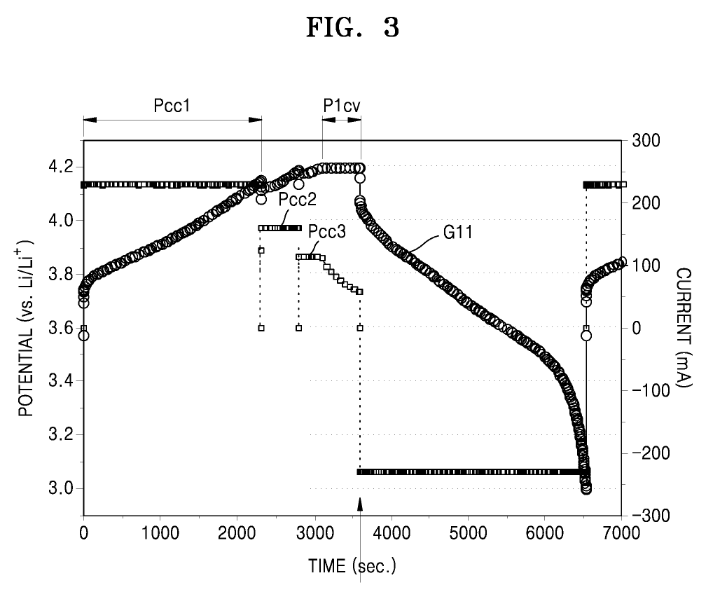

FIG. 3 is a graph showing a result of an experiment performed by a method of charging a lithium metal battery, according to an embodiment. In FIG. 3, the X-axis indicates time, the left Y-axis indicates potential, that is, voltage, and the right Y-axis indicates charge current.

An example of a cell configuration of a lithium metal battery used for the experiment is NCA//G1212A+SIL//Li (20 micrometers (μm)). Here, NCA is an example of an anode material, G1212A is an example of a separation film, SIL is an example of an electrolyte, and Li is lithium as a cathode material. More explanations for the electrolyte SIL are described in Korean Patent Application No. 10-2016-0065693. In the above experiment, a test window was approximately in a range from approximately 3.0 volts (V) to approximately 4.2 V (vs. Li/Li+). Also, different charge currents were used during multi-constant current periods Pcc1 through Pcc3 that occur prior to the constant current period P1cv. That is, in the above experiment, the charge current during the multi-constant current periods Pcc1 through Pcc3 was different from period to period. That is, the charge current during the first constant current period Pcc1 was 1 C, the charge current during the second constant current period Pcc2 was 0.7 C, and the charge current during the third constant current period Pcc3 was 0.5 C.

Referring to FIG. 3, the first constant current period Pcc1 is separated from the constant voltage period P1cv in time. Second and third constant current periods Pcc2 and Pcc3 are between the first constant current period Pcc1 and the constant voltage period P1cv. The third constant current period Pcc3 is between the second constant current period Pcc2 and the constant voltage period P1cv. The charge current during the first through third constant current periods Pcc1 through Pcc3 is discontinuously reduced. During the first constant current period Pcc1 that may be an initial constant current period, the charge is performed with the maximum current (for example, 1 C), and the charge current is gradually reduced as it goes from the second constant current period Pcc2 to the third constant current period Pcc3. The third constant current period Pcc3 may be continued until the constant voltage period P1cv occurs. When the constant voltage period P1cv occurs, the charge current may be continuously reduced until the charge is completed.

In FIG. 3, the graph G11 represents a charge voltage with respect to the lithium metal battery. Referring to graph G11, first and second voltage drops are occurred before the constant voltage period P1cv occurs. The second voltage drop exists between the first voltage drop and the constant voltage period P1cv. At the point when the first voltage drop occurs, the charge current may be changed from the first constant current period Pcc1 to the second constant current period Pcc2. The second constant current period Pcc2 may be continued until the second voltage drop occurs. The second voltage drop starts at a voltage higher than a voltage at which the first voltage drop starts. At a point when the second voltage drop occurs, the charge current may be changed from the second constant current period Pcc2 to the third constant current period Pcc3. The third constant current period Pcc3 may be continued until the constant voltage period P1cv occurs. The constant voltage period P1cv may be maintained until the charge is completed.

In the charge experiment of a lithium metal battery, in which the multi-constant current periods Pcc1 through Pcc3 and the constant voltage period P1cv as depicted in FIG. 3 occur, it took approximately 3,600 seconds for the charge completion.

A charge experiment (hereinafter, a comparative experiment) was performed by a charging method of the related art in order to compare the comparative experiment with the experiment of FIG. 3. The charging method of the related art is a conventional constant current-constant voltage (“CC-CV”) method including a CC period and a CV period and do not include a multi-constant current period. A lithium metal battery used in the comparative experiment was the same lithium metal battery used in the charge experiment of FIG. 3.

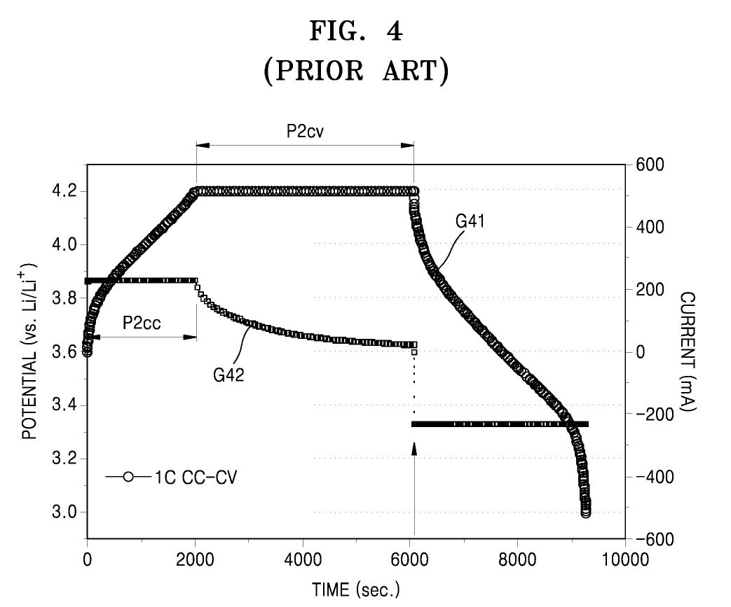

FIG. 4 is a graph showing a process of the comparative experiment from a charge start to a charge completion.

In FIG. 4, a graph G41 indicates a change voltage and a graph G42 indicates a charge current. In FIG. 4, the X-axis, the left Y-axis, and the right Y-axis respectively correspond to the X-axis, the left Y-axis, and the right Y-axis of FIG. 3.

Referring to FIG. 4, only one constant current period P2cc and only one constant voltage period P2cv occur from the start to the completion of charging. The constant current period P2cc starts together with the start of the charging. The constant current period P2cc is continued until the constant voltage period P2cv occurs. The charge current is reduced as the constant voltage period P2cv starts, and is continuously reduced until the charging is completed. The constant voltage period P2cv is continued until the charging is completed. In the comparative experiment of FIG. 4, it took approximately 6,072 seconds for the completion of charging.

Comparing the experiment results of FIGS. 3 and 4, it is seen that when a charge is performed by a charging method in which the multi-constant current periods Pcc1 through Pcc3 occur, that is, the charging method according to the aforementioned embodiment is used, the constant voltage period is shorter when compared to the conventional charging method of CC-CV periods.

Also, it is seen that the time for charging a lithium metal battery by the charging method according to the aforementioned embodiment is much shorter than the time for charging a lithium metal battery by the conventional charging method of CC-CV periods. Accordingly, when the charging method according to the aforementioned embodiment is used, a rapid charge is possible when compared to the charging method of the related art. That is, a high speed charging is possible.

When the charging method according to the aforementioned embodiment is used, in numbers, the charge time is reduced to 1/1.8 in comparison with the case of using the charging method of the related art.

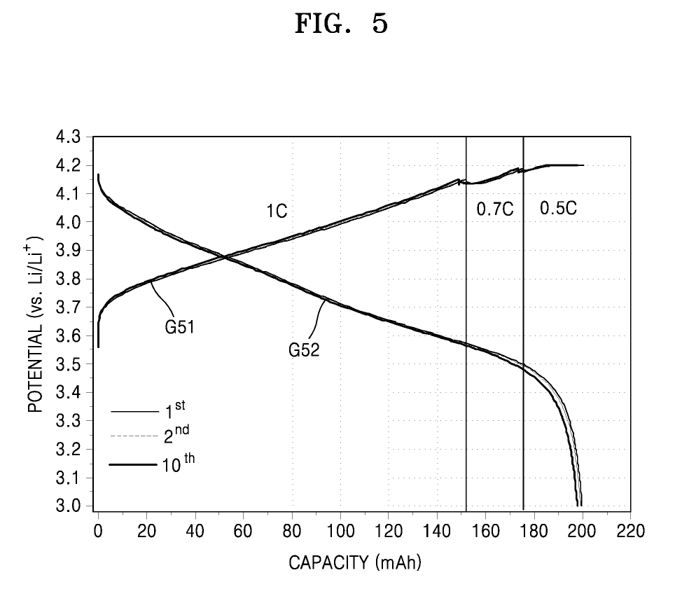

FIG. 5 is a graph showing a capacity of a lithium metal battery charged according to the charging method of FIG. 3.

In FIG. 5, the X-axis indicates capacity and the Y-axis indicates potential. A graph G51 represents a charge voltage, and a graph G52 represents a capacity change according to charge. In graph G51, 1 C indicates a voltage period corresponding to the first constant current period Pcc1 of FIG. 3, 0.7 C indicates a voltage period (the period between the first voltage drop and the second voltage drop) corresponding to the second constant current period Pcc2 of FIG. 3, and 0.5 C indicates a voltage period corresponding to the third constant current period Pcc3 of FIG. 3 and a constant voltage period from the end of the third constant current period Pcc3 to the charge completion. The results of FIG. 5 are obtained by performing the charging once, twice, and ten times, but they are not clearly distinguished from each other due to overlap each other.

Referring to FIG. 5, it is seen that the capacity of the lithium metal battery at the charge completion point is approximately 201 milliampere hour (mAh).

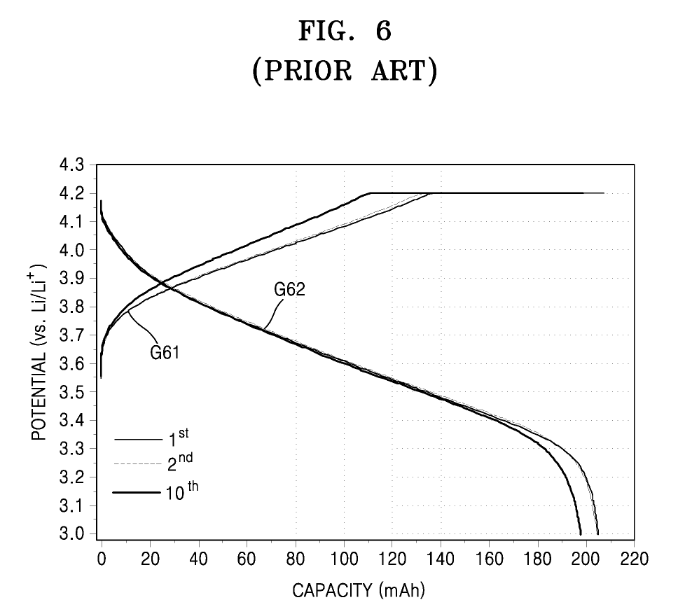

FIG. 6 is a graph showing a capacity of a lithium metal battery charged according to the charging method (a conventional charging method of the related art) of FIG. 4. A graph G61 represents a charge voltage, and a graph G62 represents a capacity change according to charging. Like in FIG. 5, the X-axis and the Y-axis respectively indicate capacity and potential. The number of charging times is also the same as in FIG. 5.

Referring to FIG. 6, it is seen that the capacity of the lithium metal battery at the charge completion point is approximately 201 mAh.

Comparing FIGS. 5 and 6, it is seen that the capacities of the lithium metal battery are almost equal when the lithium metal battery is charged with the charging method according to the aforementioned embodiment and the conventional charging method of the related art. The result denotes that, when the charging method according to the aforementioned embodiment is used, the charge time may be reduced while the capacity of the lithium metal battery is ensured at the same level when compared to the conventional charging method of the related art.

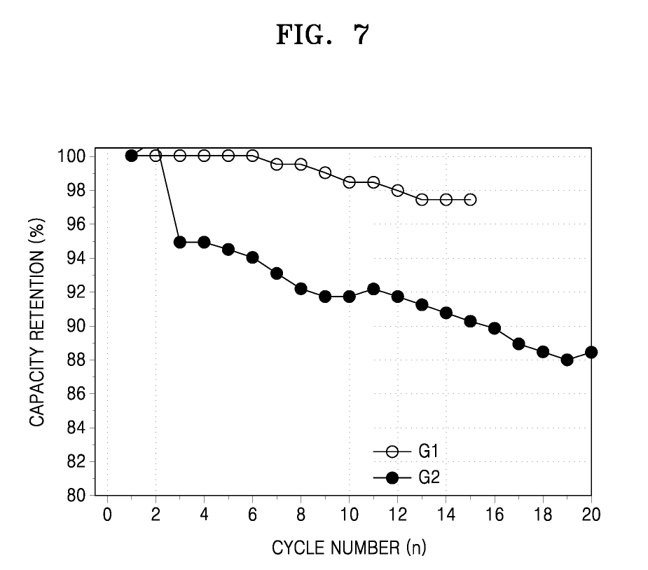

FIG. 7 is a graph showing capacity retentions of lithium metal batteries according to cycle number of the lithium metal battery when the batteries are charged by the charging method according to the aforementioned embodiment and the conventional charging method of the related art as depicted in FIG. 4. The X-axis indicates cycle numbers and the Y-axis indicates capacity retention. The first graph G1 represents the capacity retention when a lithium metal battery is charged by the charging method according to the aforementioned embodiment. The second graph G2 represents the capacity retention when a lithium metal battery is charged by the conventional charging method of the related art as depicted in FIG. 4.

Referring to FIG. 7, when a lithium metal battery is charged by the charging method according to the aforementioned embodiment, the lithium metal battery has capacity retention much higher than that of a lithium metal battery charged by the conventional charging method of the related art. The result denotes that the capacity reduction of the lithium metal battery according to cycle number is small when the lithium metal battery is charged by the charging method according to the aforementioned embodiment compared to when the lithium metal battery is charged by the conventional charging method of the related art.

From the above result, it may be confirmed that a lifetime characteristic of the lithium metal battery is increased when the lithium metal battery is charged by the charging method according to the aforementioned embodiment compared to when the lithium metal battery is charged by the conventional charging method of the related art, and accordingly, the lithium metal battery may be used for a longer time.

When taking into account that the lifetime reduction of a lithium metal battery is related to dendritic growth of lithium, the result of FIG. 7 may denote that the dendritic growth of lithium may be repressed when the lithium metal battery is charged by the charging method according to the aforementioned embodiment.

The method of charging a lithium metal battery, according to the aforementioned embodiment, includes a multi-constant current period. An effect, for example, an atmosphere of increasing the possibility of decomposing an electrolyte according to a long hour retention in a high voltage period that may occur when the lithium metal battery is charged with a high rate constant current may be minimized.

As described above, when the method of charging a lithium metal battery, according to the aforementioned embodiment, is used, the lifetime characteristic of the lithium metal battery is increased and a high speed charge is possible. Therefore, the method of charging a lithium metal battery, according to the aforementioned embodiment, may be applied to information technology (“IT”) fields, for example, mobile fields and electrical vehicles that require a high speed charge.

While one or more embodiments are described with reference to the figures, it will be understood by those of ordinary skill in the art that various changes in form and details may be made therein without departing from the spirit and scope as defined by the following claims.

What is claimed is:

1. A method of charging a lithium metal battery, the method comprising:
charging the lithium metal battery so that a constant voltage period and a first constant current period are separated from each other in time.

2. The method of claim 1, wherein
the lithium metal battery is charged so that a second constant current period occurs between the first constant current period and the constant voltage period, wherein a current value of the second constant current period is less than a current value of the first constant current period.

3. The method of claim 2, wherein
the lithium metal battery is charged so that a third constant current period occurs between the second constant current period and the constant voltage period, and
a current value of the third constant current period is less than that of the second constant current period.

4. The method of claim 2, wherein
when a voltage of the constant voltage period is referred to as V1, the second constant current period occurs at a voltage equal to or greater than approximately 0.80V1.

5. The method of claim 3, wherein
when a voltage of the constant voltage period is referred to as V1, the third constant current period occurs at a voltage equal to or greater than approximately 0.90V1.

6. The method of claim 2, wherein
the current value of the second constant current period is equal to or less than approximately 80 percent of the current value of the first constant current period.

7. The method of claim 3, wherein
the current value of the third constant current period is equal to or less than approximately 60 percent of the current value of the first constant current period.

8. A method of charging a lithium metal battery, the method comprising:
reducing a charge current to be lower than a current of a constant current period before a constant voltage period occurs.

9. The method of claim 8, wherein
the reducing the charge current comprises discontinuously reducing the charge current until a point when the constant voltage period starts.

10. The method of claim 8, wherein
the reducing the charge current comprises reducing the charge current at least once.

11. The method of claim 8, wherein
the reducing the charge current comprises reducing the charge current at a voltage equal to or greater than approximately 80 percent of the voltage of the constant voltage period.

12. A method of charging a lithium metal battery, in which a constant voltage period and a constant current period occur, the method comprising:
confirming occurrence of a voltage drop before the constant voltage period occurs;
measuring a degree of the voltage drop when the constant voltage period occurs;
comparing the degree of the voltage drop with a set value; and
reducing a charge current when the degree of the voltage drop is greater than the set value.

13. The method of claim 12, wherein
when the degree of the voltage drop is less than the set value, the reducing the charge current comprises maintaining the charge current without reducing the charge current.

14. The method of claim 12, wherein
when another voltage drop occurs after the charge current has been reduced, a subsequent process may be performed according to the processes which are performed after the voltage drop is occurred

15. The method of claim 12, wherein
the reducing the charge current comprises reducing the charge current to be equal to or less than approximately 80 percent of a current value of the constant voltage period.

16. The method of claim 12, wherein
the voltage drop occurs at a voltage equal to or greater than approximately 80 percent of the voltage of the constant voltage period.

17. The method of claim 14, wherein
another voltage drop occurs at a voltage equal to or greater than approximately 90 percent of the voltage of the constant voltage period.

18. The method of claim 14, wherein
when the reducing the charge current is repeated after the reducing the charge current, the charge current is reduced to be equal to or less than approximately 60 percent of a current value of the constant current period.
